(19) United States
(12) Patent Application Publication
(10) Pub. No.: US 2004/0021892 A1
(43) Pub. Date: Feb. 5, 2004

(54) Method and apparatus for printing

(75) Inventor: Tsutomo Ueda, Shizuoka-ken (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/210,094

(22) Filed: Aug. 2, 2002

(51) Int. Cl. G06K 1/00; G06F 15/00; B41F 1/00

(52) U.S. Cl. 358/1.14; 358/1.1

(57) ABSTRACT

An apparatus for printing comprises a comparator configured to compare an amount of information with a preset value, and a controller configured to control printing of the information. The controller suspends printing when the comparator detects an amount of information that is smaller than the preset value, causes a printer to print the information smaller in amount than the preset value, and causes a printer to restart the printing suspended, after the information smaller in amount than the preset value is completely printed.

### BACKGROUND OF THE INVENTION

1. Field of the Invention

The present invention relates to a method and apparatus for printing information transmitted from an external apparatus.

2. Description of the Related Art

An apparatus for printing is connected with a plurality of terminals through a network. Printing information is created at each terminal, sent through a network to an apparatus for printing, and stored in a memory. The stored printing information is sequentially read and printed.

Therefore, the printing information stored later in the memory is not printed until printing of the information stored earlier is finished. Generally, a small amount of information can be printed in a short time. However, a waiting time must be added if there is other information stored earlier. Particularly, when other information requires a long time to print, the waiting time becomes longer by the time needed to print the other information. As a result, it sometimes takes a long time to print information requested by a terminal user. The user must wait for a long time to execute printing.

Thus, there has been demanded an apparatus for printing which can suspend printing when receiving a small amount of information, and print the smaller amount first.

### BRIEF SUMMARY OF THE INVENTION

According to aspects of the prevent invention, there is provided an apparatus for printing information transmitted from an external apparatus.

An apparatus for printing of the present invention comprises a comparator configured to compare an amount of information with a preset value, and a controller configured to control printing of the information.

The controller suspends printing when the comparator detects an amount of information that is smaller than the preset value, causes a printer to print the information smaller in amount than the preset value, and causes the printer to restart the printing suspended, after the information smaller in amount than the preset value is completely printed.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and comprise a part of the specification, illustrate embodiments of the invention, and together with the general description given above and the detailed description of the embodiments given below, serve to explain the principles of the invention.

FIG. 1 is a schematic block diagram of an apparatus for printing according to an embodiment of the present invention;

FIG. 2 is a view showing main storage areas of a disk unit of the apparatus for printing;

FIG. 3 is a view showing main storage areas of a main memory of the apparatus for printing;

FIG. 4 is a flow chart showing the main operations of a system controller of the apparatus for printing;

FIG. 5 is a flow chart showing the steps of the interrupt printing shown in FIG. 4;

FIG. 6 is a timing diagram explaining the effects of the apparatus for printing;

FIG. 7 is a timing drawing explaining the effects of the apparatus for printing; and

FIG. 8 is a flow chart showing another embodiment of the interrupt printing.

### DETAILED DESCRIPTION OF THE INVENTION

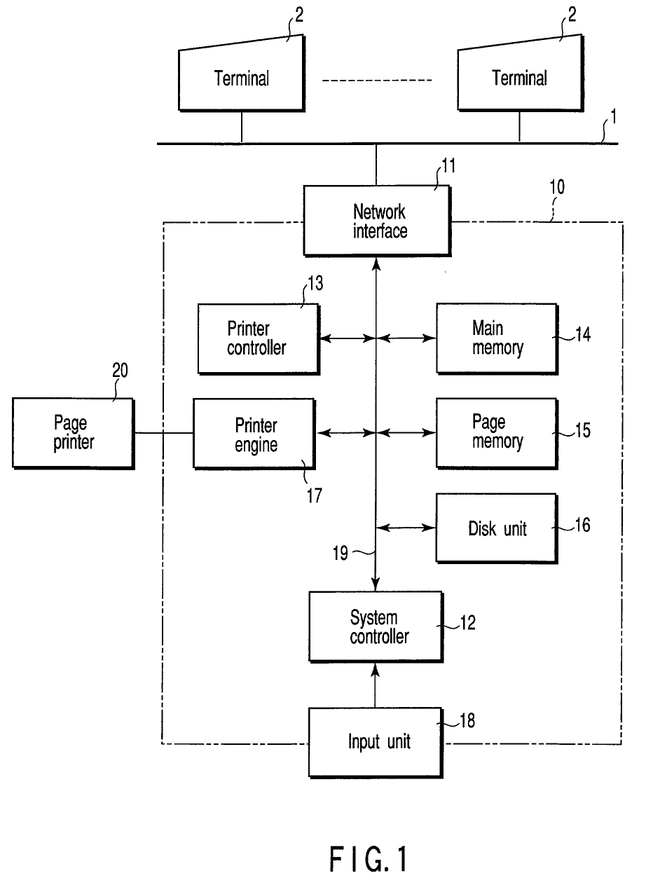

Hereinafter description will be given on an apparatus for printing according to an embodiment of the present invention with reference to FIG. 1-FIG. 5.

In FIG. 1, an apparatus for printing 10 is connected to a network 1. A plurality of terminals 2 is connected to the network 1. Print job information is created at each terminal 2. The created print job information is sent to the apparatus for printing 10 through the network 1. Print job information comprises printing information such as characters, graphics, images and so on, and print control information such as paper size, number of copies, font and so on.

The apparatus for printing 10 comprises a network interface 11, a system controller 12, a printer controller 13, a main memory 14, a page memory 15, a disk unit 16, a printer engine 17 and an input unit 18.

The input unit 18 includes a power switch of the apparatus for printing 10. The input unit 18 is constructed to make various settings. The information set by the input unit 18 is supplied to the system controller 12.

The system controller 12 is connected to the network interface 11, printer controller 13, main memory 14, page memory 15, disk unit 16 and printer engine 17, through a system bus 19.

The network interface 11 is constructed to receive print job information through the network 1. The printer controller 13 is constructed to form bit map images of printing information based on the print job information. The main memory 14 is constructed to store various data. The page memory 15 is constructed to store the bit map images formed by the printer controller 13. The disk unit 16 is constructed to store the print job information and various setting values. The printer engine 17 is constructed to supply the printing information developed into bit map images to the page printer 20 to make printing on paper.

The page printer 20 is constructed to print on one piece of paper the bit map images for one page supplied from the apparatus for printing 10. A laser beam printer, an ink jet printer or a thermal transfer printer can be used as a page printer 20.

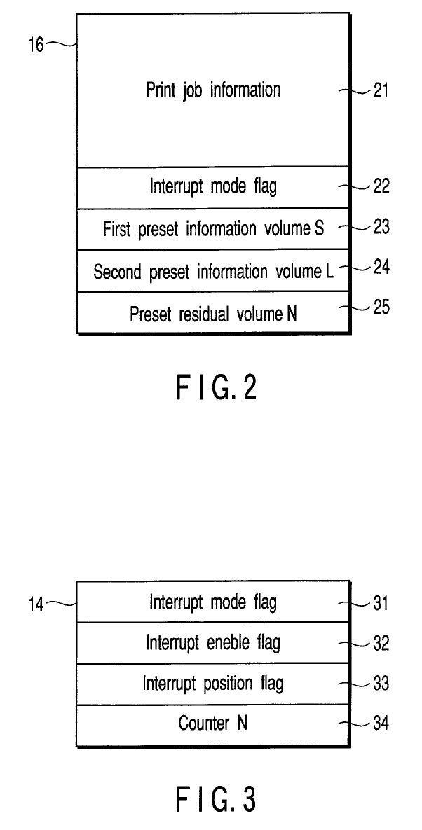

Referring now to FIG. 2, the main data storage area in the disk unit 16 will be explained.

Storage areas 21, 22, 23, 24 and 25 are formed in the disk unit 16. The storage area 21 sequentially stores print job information sent from each terminal 2 through the network 1.

Other storage areas 22-25 previously store the information entered through the input unit 18; the area 22 stores the default value of an interrupt mode flag entered from the input unit 18, the area 23 stores a first preset information volume S, the area 24 stores a second preset information volume L, and the area 25 stores a preset residual volume N.

The preset information volumes S and L are compared to the initial information volume of printing information. The second preset value L is larger than the first preset value S. For example, when the second preset value L is equivalent to 10 pages of standard size paper, the first preset value S is equivalent to 1 page. The preset residual volume N is compared to the residual information volume of the printing information being printed in units of page by the page printer 20 for each page. For example, the preset residual volume N is equivalent to 2 pages of standard size paper.

The apparatus for printing 10 has an interrupt mode to change the order of printing according to the amount of printing information. When an interrupt mode flag is ON, the interrupt mode is valid. When the interrupt mode is valid, interrupt priority is given to the printing information whose information volume is smaller than the first preset value S. The chosen printing information can be printed during printing the information larger than the second preset value L. However, when the residual information volume of the printing information larger than the second preset value L is less than the preset residual volume N, interrupt printing is disabled.

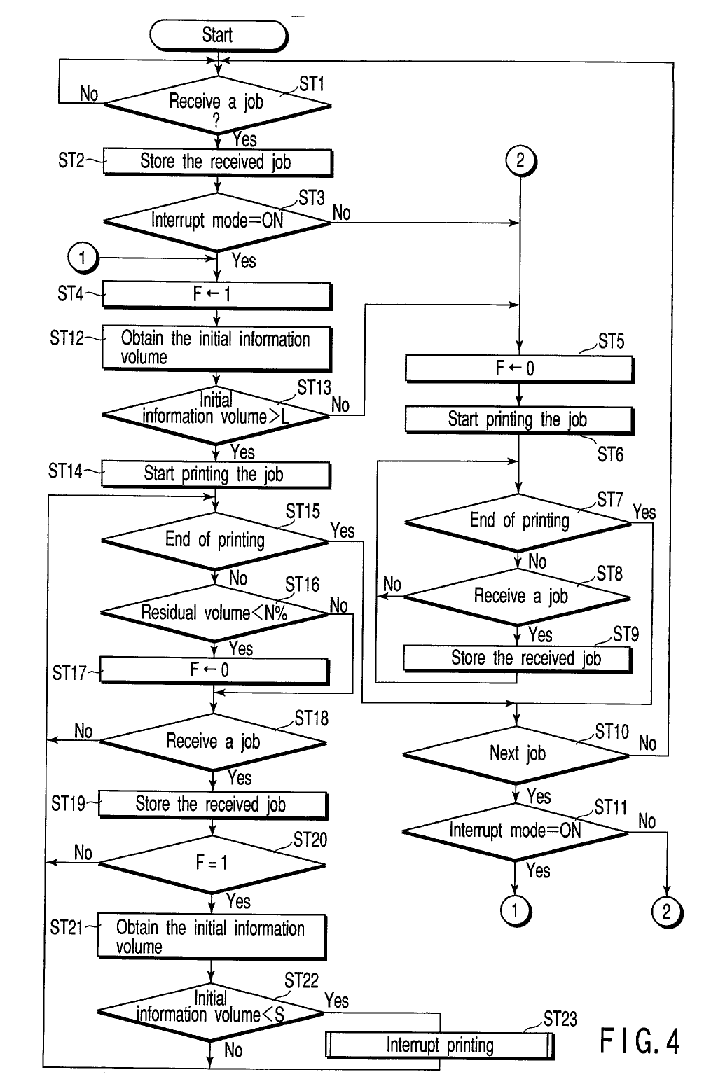

The main data storage areas of the main memory 14 will be explained by referring to FIG. 3.

Storage areas 31, 32, 33 and 34 are formed in the main memory 14. These storage areas 31-34 are used as work areas of the system controller 12. The storage area 31 stores an interrupt mode flag. When the power switch 18 is turned on, the system controller 12 reads the interrupt mode flag in the disk unit 16, and stores it in the storage area 31 of the main memory.

The storage area 32 stores an interrupt enable flag F. The interrupt enable flag F is set to 1 to enable interrupt printing of the printing information smaller than the first preset value S. The flag is reset to 0 to disable interrupt printing.

The storage area 33 stores data indicating the interrupt position (address), when printing of information is suspended for interrupt printing of other information smaller the first preset value S. The storage area 34 stores a counter K to count the amount of printing information queued for interrupt printing.

Main operations of the system controller 12 will be explained by referring to the flow chart of FIG. 4.

When the power switch is turned on, the system controller 12 makes initial setting. In the initial setting, the interrupt mode flag in the disk unit 16 is read and stored in the storage area 31 of the main memory 14.

After the initial setting, the system controller 12 starts the processes shown in FIG. 4. First, the system controller 12 waits for print job information, in step ST1. When print job information is sent from the terminal 2 to the network interface 11, the system controller 12 notifies that print job information has been received. Then, the system controller 12 stores the print job information in the storage area 21 of the disk unit 16, in step ST2.

Next, the system controller 12 examines the interrupt mode flag, in step ST3. The interrupt mode flag is stored in the storage area 31 of the main memory 14. When the interrupt mode flag is ON, the system controller 12 sets the interrupt enable flag F to 1, in step ST4. If the interrupt mode flag is OFF, the system controller 12 resets the interrupt enable flag F to 0, in step ST5.

After resetting the interrupt enable flag F, the system controller 12 commands the printer controller 13 to start printing of one print job information, in step ST6.

Commanded to start printing, the printer controller 13 reads first print job information from the storage area 21. Then, the printer controller 13 creates bit map images of printing information page-by-page based on the print control information included in that print job information. The bit map images created in units of page are sequentially stored in the page memory 15. The bit map images are then sent from the page memory 15 to the page printer 20 through the printer engine 17, and printed on paper. Therefore, in the page printer 20, the printing information included in the print job information is outputted and printed page-by-page.

After commanding to start printing, the system controller 12 waits until the printing started by one print job information is finished, in step ST7. During this waiting period, the system controller 12 monitors in step ST8 whether the next print job information is received or not. When the next print job information is received, the system controller 12 sequentially stores that print job information in the storage area 21, in step ST9.

After the printing is finished, the system controller 12 judges in step ST10 whether the next print job information is stored in the storage area 21. If the print job information is not stored, the system controller 12 returns to step ST1.

When the next print information is stored, the system controller 12 examines the interrupt mode flag, in step ST11. When the interrupt mode flag is OFF, the system controller 12 returns to step ST5. Therefore, the system controller 12 commands the printer controller 13 to start printing the print job information.

When the interrupt mode flag is ON, the system controller 12 returns to step ST4.

When the interrupt enable flag F is set, the system controller 12 obtains the initial information volume of the printing information included in a first print job information stored in the storage area 21, in step ST12. Then, the system controller 12 compares the initial information volume to the second preset information volume L, in step ST13. The second preset information volume L is stored in the storage area 24 of the disk unit 16.

When the initial information volume is equal to or smaller than the second preset information volume L, the system controller 12 goes to step ST5. Therefore, after resetting the interrupt enable flag F to 0, the system controller 12 commands the printer controller 13 to start printing the print job information.

When the initial information volume is larger than the second preset information volume L, the system controller 12 commands the printer controller 13 to start printing the print job information, in step ST14. Thereafter, the system controller 12 waits until the printing of one print job information is finished, in step ST15.

During this period, the system controller 12 monitors in step ST16 whether the residual volume of this print job information being printed is equal to or less than the preset residual volume N. The preset residual volume N is stored in the storage area 25 of the disk unit 16. The residual printing volume is controlled by the printer controller 13. When the residual printing volume of the print job information becomes equal to or lower than the preset residual volume N, the system controller 12 resets the interrupt enable flag F to 0, in step ST17.

The system controller 12 monitors in step ST18 whether the next print job information is received or not. When the next print job information is received, the system controller 12 sequentially stores that print job information in the storage area 21 of the disk unit 16, in step ST19.

Then, the system controller 12 examines the interrupt enable flag F, in step ST20. When the interrupt enable flag F is reset to 0, the system controller 12 returns to step ST15.

When the interrupt enable flag F is set to 1, the system controller 12 obtains the initial information volume of the printing information from the print job information stored in the storage area 21, in step ST21. Then, the system controller 12 compares the initial information volume to the first preset information volume S, in step ST22. The first preset information volume S is stored in the storage area 23 of the disk unit 16.

When the initial information volume is equal to or larger than the first preset information volume S, the system controller 12 returns to step 15.

When the initial information volume is smaller than the first preset information volume S, the system controller 12 sets this print job information as interrupt job, in step ST23. Then, the system controller 12 executes printing of this interrupt job. After finishing the interrupt printing, the system controller 12 returns to step ST15.

When finishing the printing of the first print job information stored in the storage area 12, in step ST15, the system controller 12 goes to step ST10. Therefore, when the next print job information is not stored in the storage area 12, the system controller returns to step ST1.

When the next print job information is stored in the storage area 12, the system controller 12 examines the interrupt mode flag. When the interrupt mode flag is OFF, the system controller 12 returns to step ST5. When the interrupt mode flag is ON, the system controller 12 returns to step ST4.

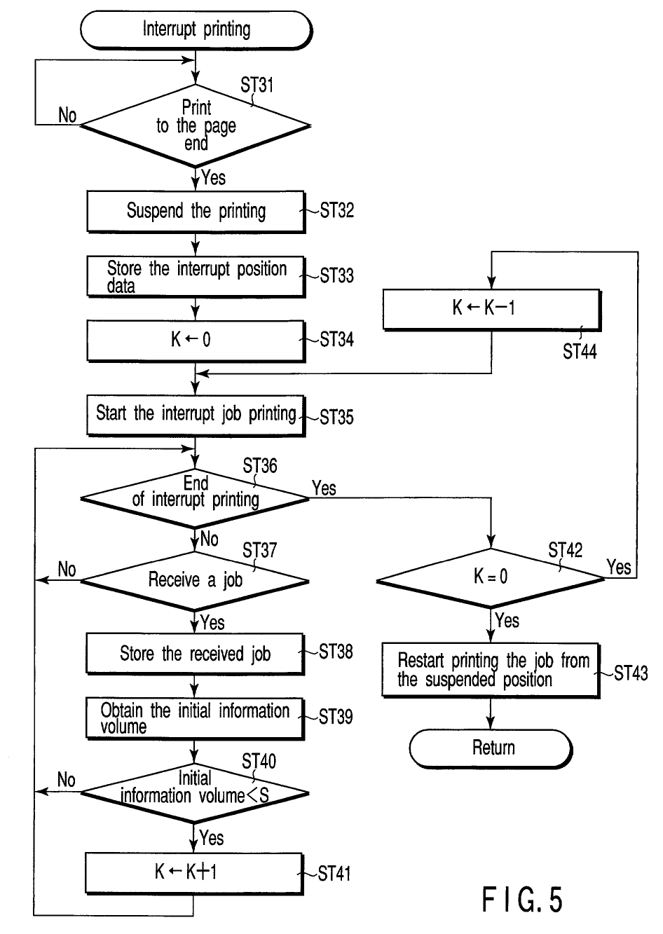

Description will now be given of the procedures of interrupt printing executed by the system controller 12 by referring to the flow chart of FIG. 5.

After starting the interrupt printing, the system controller 12 waits until the printing reaches the end of a page, in step ST31. Detecting the printing reached the end of a page by the signal from the printer controller 13, the system controller 12 commands the printer controller 13 to suspend the printing, in step ST32.

When the printing is suspended, the system controller 12 takes in the position data from the printer controller 13, in step ST33. The position data indicates the restart position of the suspended printing information. The system controller 12 stores this position data in the storage area 33 of the main memory 14.

Then, the system controller 12 resets the counter K to 0, in step ST34. The counter K is stored in the storage area 34 of the main memory 14.

Then, the system controller 12 commands the printer controller 13 to start the interrupt printing of one print job information, in step ST35.

Then, the printer controller 13 reads the print job information of the interrupt job from the storage area 21, and prints it as already explained.

After commanding to start the interrupt printing, the system controller 12 waits until the printing of that interrupt job is finished, in step ST36. During this waiting period, the system controller 12 monitors whether the next print job information is received or not, in step ST37. When the next print job information is received, the system controller 12 sequentially stores that print job information in the storage area 21 of the disk unit 16, in step ST38.

Then, the system controller 12 obtains the initial information volume of the printing information from the print job information stored in the storage area 21, in step ST39. Then, the system controller compares the initial information volume to the first preset volume S, in step ST40.

When the initial information volume is equal to or larger than the first preset volume S, the system controller returns to step ST36.

When the initial information volume is smaller than the first preset volume S, the system controller sets this print job information as interrupt job, in step ST41. Then, the system controller 12 adds 1 to the counter K, and returns to step ST36.

After finishing the printing of the print job information set as an interrupt job, the system controller 12 examines the counter K, in step ST42. When the counter K is equal to or larger than 1, the system controller 12 judges that the other job information set in the interrupt job is stored in the storage area 21. Therefore, after subtracting 1 from the counter K in step ST43, the system controller 12 re-commands the printer controller 13 to start interrupt printing.

When the counter K is 0, the system controller 12 reads the interrupt position data from the storage area 33 of the main memory 14, in step ST44. Then, the system controller 12 commands the printer controller 13 to restart printing from this interrupt position.

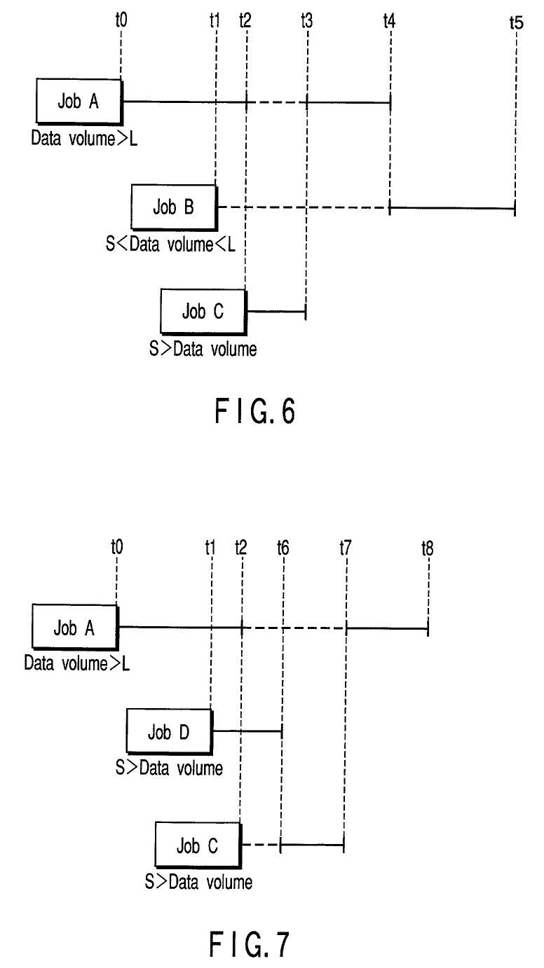

Description will now be given on the effects of the apparatus for printing 10 when the interrupt mode flag is ON, with reference to FIG. 6 and FIG. 7.

In FIG. 6 and FIG. 7, the job A is print job information having printing information whose initial information volume is larger than the second preset value L, and the job B is print job information having printing information whose initial information volume is larger than the first preset value S and smaller than the second preset value L. The jobs C and D are print job information having printing information whose initial information volume is smaller than the first preset value S.

FIG. 6 shows the timing when the apparatus for printing 10 sequentially receives the jobs A, B and C.

Receiving the print job information (the job A) at the time t0 waiting for printing, the apparatus for printing 10 starts printing the print job information (the job A).

Receiving the print job information (the job B) at the time t1 (t0<t1) during printing the print job information (the job A), the apparatus for printing 10 stores the print job information (the job B) in the storage area 21 until the printing of the print job information (the job A) is finished.

When receiving the print job information (the job C) at the time t2 (t1<t2) during printing the print job information (the job A), the apparatus for printing 10 takes a different action depending on whether the residual volume of the print job information (the job A) is smaller than the preset residual volume N or not.

When the residual printing volume is equal to or larger than the preset residual value N, the apparatus for printing 10 suspends printing the printing job information (the job A) at the end of page. Then, the apparatus for printing 10 starts interrupt printing of the print job information (the job C). When the interrupt printing is finished at the time t3 (t2<t3), the apparatus for printing 10 restarts printing the print job information (the job A). When the printing is finished at the time t4 (t3<t4), the apparatus for printing 10 starts printing the print job information (the job B).

When the residual volume of the print job information (the job A) is smaller than the preset residual value N at the time t2 receiving the print job information (the job C), the print job information (the job C) is stored in the storage area 21. The print job information (the job C) is stored after the printing job information (the job B).

Therefore, after the printing of the print job information (the job A) is finished, the printing of the print job information (the job B) is started. After the printing of the print job information (the job B) is finished, the printing of the print job information (the job C) is started.

FIG. 7 shows the timing when the apparatus for printing 10 receives the print job information of job D instead of job B. Receiving the print job information (the job D) at the time t1, the apparatus for printing 10 takes a different action depending on whether the residual volume of the print job information (the job A) is smaller than the preset value N or not.

When the residual volume is equal to or larger than the preset residual value N, the apparatus for printing 10 suspends printing the print job information (the job A) at the end of page. Then, the apparatus for printing 10 starts the interrupt printing of the print job information (the job D).

Receiving the print job information (the job C) at the time t2 during the interrupt printing, the apparatus for printing 10 adds the counter K. The print job information (the job C) is stored in the storage area 21. Therefore, after the interrupt printing of the print job information (the job D) is finished (at the time t6), the interrupt printing of the print job information (the job C) is started. After the interrupt printing of the print job information (the job C) is finished (at the time t7), the printing of the print job information (the job A) is restarted.

When the residual volume of the print job information (the job A) is smaller than the preset residual value N at the time t1 receiving the print job information (the job D), the print job information (the job D) and print job information (the job C) are stored in the storage area 21. Therefore, after the printing of the print job information (the job A) is finished, the printing of the print job information (the job D) is started. After the printing of the print job information (the job D) is finished, the printing of the print job information (the job C) is started.

Thus, as described above, the present invention prevents inconvenience that the printing information whose information volume is smaller than the first preset value S is not printed for a long time, owing to the printing of the information whose information volume is larger than the second preset value L.

However, when the residual volume of large amount printing information becomes smaller than the preset residual volume N, the apparatus for printing 10 chooses printing of the residual volume of the large printing information. While the information whose volume is smaller than the second preset value L is being printed, interrupt printing is disabled. Therefore, printing of the information requiring a shorter time will not be interrupted by another printing information.

When the interrupt mode flag is OFF, information is printed in the order it comes from the terminals 2.

The present invention is not limited by the aforementioned embodiment.

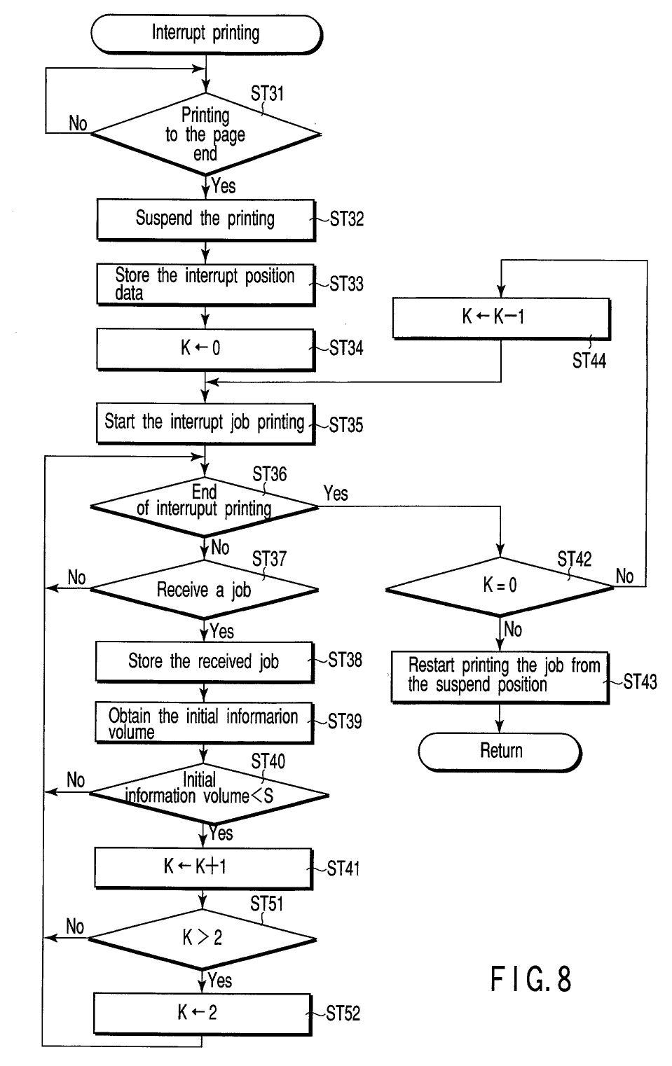

Another embodiment of interrupt printing will now be explained by referring to FIG. 8. The same reference characters are given to the same steps as those in FIG. 5.

When the counter K is added by 1 instep ST41, the system controller 12 judges whether the counter K exceeds a limited value 2, in step ST51. When the counter K exceeds 2, the system controller 12 resets the counter K to 2, in step ST52. Then, the system controller 12 returns to step ST36.

When other interruptible printing information comes in during the interrupt printing, it will be printed successively after the current interrupt printing. In this embodiment, the number of successive interrupt printing is limited to 2 or less.

The present invention includes the case where a preset information volume is limited to one value, and when another information smaller than the preset value occurs during printing the information larger than the preset value, the later information is printed as interrupt printing.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A printing apparatus for printing information transmitted from an external apparatus, comprising:
a comparator unit configured to compare an amount of information with a preset value; and
a controller unit configured to control printing of the information,
wherein the controller unit suspends the printing when the comparator unit detects an amount of information that is smaller than the preset value, causes a printer to print the information smaller in amount than the preset value, and causes the printer to restart the printing suspended, after the information smaller in amount than the preset value is completely printed.

2. A printing apparatus according to claim 1, which further comprises a detector unit configured to determine whether that part of the information that has yet to be printed is equal to or smaller in amount than a specific value, and in which the controller unit inhibits an interrupt printing of information smaller in amount than the preset value, when the detector unit determines that part of the information which has yet to be printed is equal to or smaller than the specific value.

3. A printing apparatus according to claim 1, which further comprises a setting unit configured to set an interrupt print mode, and in which the controller unit enables interrupt printing of information smaller in amount than the preset value, when the setting unit sets the interrupt print mode.

4. A printing apparatus according to claim 1, which further comprises a setting unit configured to set an interrupt print mode, and a detector unit configured to detect whether that part of the information that has yet to be printed is equal to or smaller in amount than a specific value, and in which the controller unit allows for interrupt printing of information smaller in amount than the preset value, when the setting unit sets the interrupt print mode, and inhibits the interrupt printing, the detector unit determines that part of the information which has yet to be printed is equal to or smaller than the specific value while when the interrupt mode remains set.

5. A printing apparatus for printing information transmitted from an external apparatus, comprising:
a first comparator configured to compare the amount of the information with a first preset value;
a second comparator configured to compare the amount of the information with a second preset value equal to or larger than the first preset value; and
a controller unit configured to control printing of the information,
wherein the controller unit suspends the printing when the first comparator detects an amount of information smaller than the first preset value while an amount of information which the second comparator has detected to be larger than the second preset value is being printed; starts interrupt printing of the information smaller in amount than the first preset value; and restarts the printing suspended, after the information smaller in amount than the first preset value is completely printed.

6. The apparatus for printing according to claim 5, wherein the controller unit inhibits interrupt printing of the information smaller in amount than the first preset value, when a request is generated for printing of the information smaller in amount than the second preset value.

7. A printing apparatus according to claim 5, which further comprises a detector unit configured to determine whether that part of information which has yet to be printed is equal to or smaller in amount than a specific value, and in which the controller unit inhibits interrupt printing of the information smaller in amount than the first preset value, when the detector unit determines that part of the information which has yet to be printed is equal to or smaller in amount than the specific value.

8. A printing apparatus according to claim 5, which further comprises a setting unit configured to set an interrupt print mode, and in which the controller unit allows for interrupt printing of the information smaller in amount than the first preset value, when the mode selector sets the interrupt print mode.

9. A printing apparatus according to claim 8, wherein the controller unit inhibits interrupt printing of the information smaller in amount than the first preset value, when a request is generated for printing the information smaller than the second preset value while the interrupt print mode remains set.

10. A printing apparatus according to claim 5, which further comprises a setting unit configured to set an interrupt print mode, and a detector unit configured to determine whether that part of the information which has yet to be printed is equal to or smaller than a specific value,
wherein the controller unit allows for interrupt printing of information smaller in amount than the first preset value when the setting unit sets the interrupt print mode, and inhibits the interrupt printing, when the detector unit determines that part of the information which has yet to be printed is equal to or smaller in amount than the specific value while the interrupt print mode remains set.

11. A printing method for printing information transmitted from an external apparatus, comprising:
suspending printing of printing information larger in amount than a second preset value when printing information smaller in amount than a first preset value equal to or smaller in amount than the second preset value is transmitted from the external apparatus;
starting interrupt printing of the information smaller in amount than the first preset value; and
restarting the printing suspended, after the information smaller in amount than the first preset value is completely printed.

12. A printing method according to claim 11, further comprising:
inhibiting interrupt printing of the printing information smaller in amount than the first preset value, while the printing information smaller than the second preset value is being printed.

13. A printing method according to claim 11, further comprising:
determining whether that part of the information which has yet to be printed is equal to or smaller in amount than a specific value; and
inhibiting interrupt printing of the information smaller in amount than the first preset value when that part of the information which has yet to be printed is determined to be equal to or smaller in amount than the specific value.

14. A printing method according to claim 11, further comprising:
setting an interrupt print mode;
allowing for interrupt printing of the information smaller in amount than the first preset value when the interrupt print mode is set; and
inhibiting the interrupt printing when the interrupt print mode is reset.

15. A printing method according to claim 11, further comprising:
setting an interrupt print mode;
allowing for interrupt printing of the information smaller in amount than the first preset value when the interrupt print mode is set;
inhibiting the interrupt print mode when the interrupt print mode is reset;
determining whether that part of the information which has yet to be printed is equal to or smaller in amount than a specific value, while the interrupt print mode remains set; and
inhibiting the interrupt printing until the information is completely printed, when that part of the information which has yet to be printed is determined to be equal to or smaller in amount than a specific value.
